(19) United States
(12) Patent Application Publication
(10) Pub. No.: US 2011/0171374 A1
(43) Pub. Date: Jul. 14, 2011

(54) Dispersion-Compensated Infra Red Cloak (D-CIRC)

(75) Inventors: Igor I. Smolyaninov, Columbia, MD (US); Nikolay K. Yushin, Herndon, VA (US); Louise C. Sengupta, Ellicott City, MD (US)

(73) Assignee: BAE Systems Information and Electronic Systems Integration Inc., Nashua, NH (US)

(21) Appl. No.: 12/968,663

(22) Filed: Dec. 15, 2010

Related U.S. Application Data
(60) Provisional application No. 61/286,553, filed on Dec. 15, 2009.

(51) Int. Cl. B05D 5/06

(52) U.S. Cl. 427/160; 427/162

(57) ABSTRACT

A method of achieving electromagnetic cloaking of an object comprising the step of coating said object with a metal-dielectric composite material including a dielectric component, wherein the dielectric component is comprised of a material exhibiting anomalous dispersion in a wide wavelength range.

### CROSS-REFERENCE TO RELATED APPLICATION

This application claims rights under 35 U.S.C. 119(e) from U.S. Application Ser. No. 61/286,553 filed Dec. 15, 2009, the contents of which are incorporated herein by reference.

### BACKGROUND OF THE INVENTION

1. Field of the Invention

The present invention relates to electromagnetic cloaking and more particularly to using metamaterials to achieve electromagnetic cloaking.

2. Brief Description of Prior Developments

Electromagnetic cloaking is an advanced stealth technology which allows an object to be partially or wholly invisible to parts of the electromagnetic spectrum.

The prior art has recently suggested a number of optical metamaterials that owe their refractive properties to the way they are structured rather than to the substances which compose them.

U.S. Published Patent Application 2008/0165442 by Cai et al., for example, discloses a method and apparatus for cloaking in which an object to be clocked is disposed such that the cloaking apparatus is between the object and an observer. The appearance of the object is altered and, in the limit, the object cannot be observed, and the background appears unobstructed. The cloak is formed of a metamaterial where the properties of the metamaterial are varied as a function of distance from the cloak interfaces, and the permittivity is less than unity. The metamaterial may be fabricated as a composite material having a dielectric component and inclusions of particles of sub-wavelength size, so as to have a permeability substantially equal to unity.

Other prior art references disclosing electromagnetic cloaking using metamaterials are as follows:
1. J. B. Pendry, D. Schurig, D. R. Smith, Science 312, 1780 (2006).
2. U. Leonhardt, Science 312, 1777 (2006).
3. D. Schurig, J. J. Mock, B. J. Justice, S. A. Cummer, J. B. Pendry, A. F. Starr, D. R. Smith, Science 314, 977 (2006).
4. W. Cai, U. K. Chettiar, A. V. Kildishev, V. M. Shalaev, Nature Photonics 1, 224 (2007).

Such recently suggested metamaterial-based coatings (cloaks) may, however, operate only in some pre-selected very narrow frequency ranges of the electromagnetic spectrum, due to very strong dispersion properties of the metal components used in the metamaterials.

A need, therefore, exists for a coating which would reduce visibility of an object in a given, relatively wide electromagnetic frequency range.

### SUMMARY OF INVENTION

The present invention comprises a metal-dielectric composite, in which the dielectric component is made of a material exhibiting anomalous dispersion in a wide wavelength range (in such manner that its dielectric permittivity and refractive index increase with the increase of the wavelength of light), meanwhile the metal dielectric permittivity is negative in the infrared and its magnitude increases with the wavelength. As a result, the average refractive index of the metal-dielectric composite may be kept constant in a wide wavelength range at a level between n=0 (at the inside boundary of the coating) and n=1 (at the outside boundary), depending on the local composition of the metamaterial. Such distribution of the refractive index accompanied by very low overall dispersion would create conditions of total transmission (that is, zero reflection) for the external illumination, and total internal reflection for thermal radiation generated by a heated object inside the cloak. This metamaterial coating provides previously unavailable suppression of visibility of an object in a wide wavelength range, including practically important range of the infra red radiation generated by heat (1-14 μm). The object can be a vehicle or tank with a running engine.

### BRIEF DESCRIPTION OF THE DRAWINGS

The present invention is further described with reference to the accompanying drawings wherein:

FIG. 1 is a vertical schematic cross sectional drawing showing a dispersion-compensated metamaterial made of alternating layers of metal (such as gold Au or silver Ag) and dielectric (for example, PFCB-BP film, similar to Teflon), wherein the thicknesses of metal and dielectric layers have to be much smaller than the operating wavelength;

FIG. 2 is a graph which is a schematic representation of the dispersion compensation mechanism;

FIG. 3 is a graph showing power density of typical thermal sources as a function of wavelength;

FIGS. 4(a) and 4(b) are, respectively graphs showing anomalous refractive behavior of the PFCB-BP Teflon as presented in Ballato et al., JOSA B 20, 1838-1843 (b) calculated effective dielectric constant of the metal-dielectric composite metamaterial for different relative volume ratios of gold fₘ (we assume d_{AU}=fₘd_{PFCB-BP}), wherein these calculations demonstrate that the effective dielectric constant of the metamaterial may be kept approximately constant in a wide 6-12 μm wavelength range;

FIG. 5 includes graphs showing performance antireflection coating without and with dispersion compensation.

### DETAILED DESCRIPTION OF THE PREFERRED EMBODIMENT

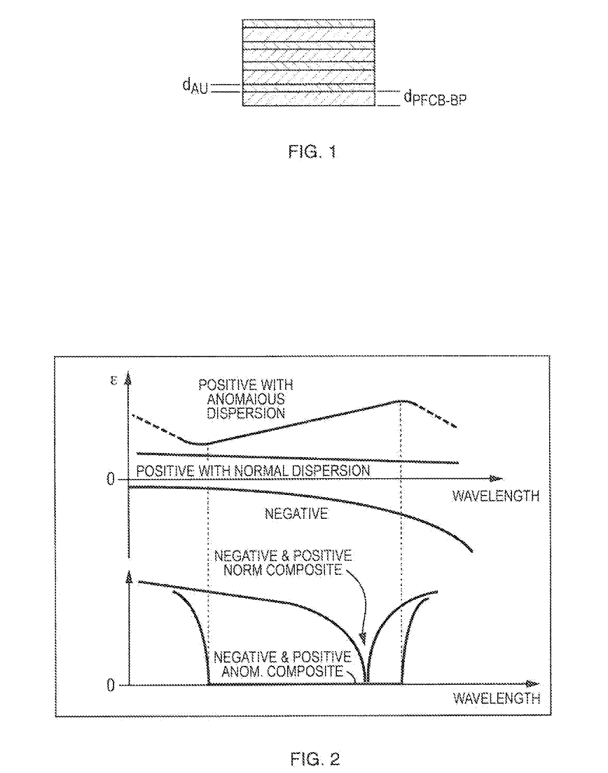

Referring to FIG. 1, the disclosed electromagnetic metamaterial consists of alternating layers of metal (such as gold, silver, copper, etc., which have a well-defined Plasmon resonance), and dielectric (such as a polymer film) which exhibits an anomalous dispersion behavior (the refractive index increases with the increase of the wavelength of light) in the frequency range in which reduced visibility must be achieved.

Referring to FIG. 2, the metal dielectric permittivity is negative in the infrared and its magnitude increases with the wavelength, while the dielectric permittivity of the dielectric layers is positive and increases with the increase of the wavelength of light. As a result, the average refractive index of the metal-dielectric composite may be kept constant in a wide wavelength range at a level between n=0 (at the inside boundary of the coating) and n=1 (at the outside boundary), depending on the local composition of the metamaterial.

Such distribution of the refractive index accompanied by very low overall dispersion would create conditions of total transmission (that is, zero reflection) for the external illumination, and total internal reflection for thermal radiation generated by a heated object inside the cloak. This metamaterial coating provides previously unavailable suppression of visibility of an object in a wide wavelength range, including practically important range of the infra red radiation generated by heat (1-14 μm). The object can be a vehicle or tank with a running engine.

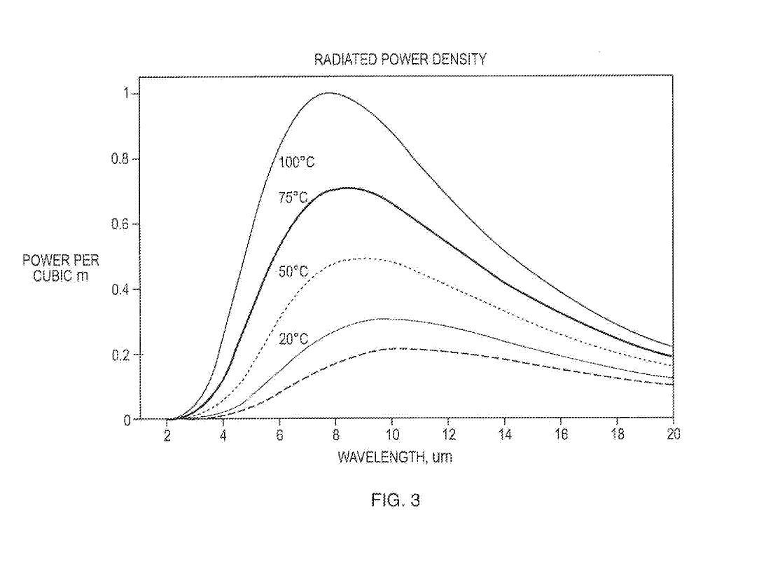

The described method allows us to reduce visibility of an object in a wide wavelength range (not just at one fixed frequency), as shown in FIG. 2. This feature of our invention is very important because typical thermal sources emit electromagnetic radiation in a wide wavelength range (FIG. 3).

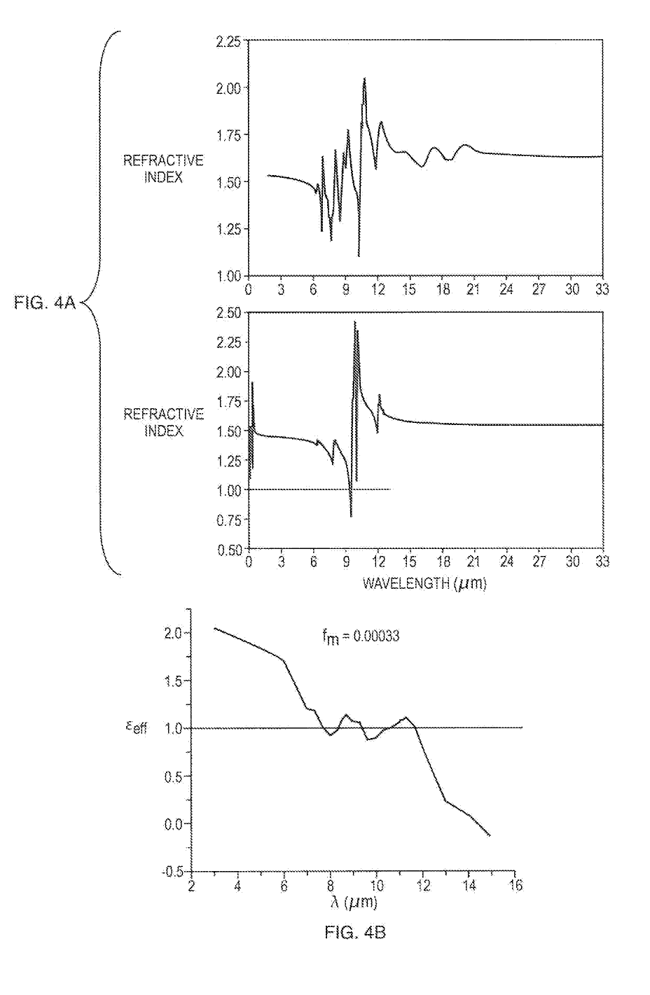

Our invention is supported by the numerical calculations of the effective refractive index of a multilayer gold/Teflon metamaterial presented in FIG. 4.

ε_{eff}=(1−fₘ)ε_{b}+fₘεₐ

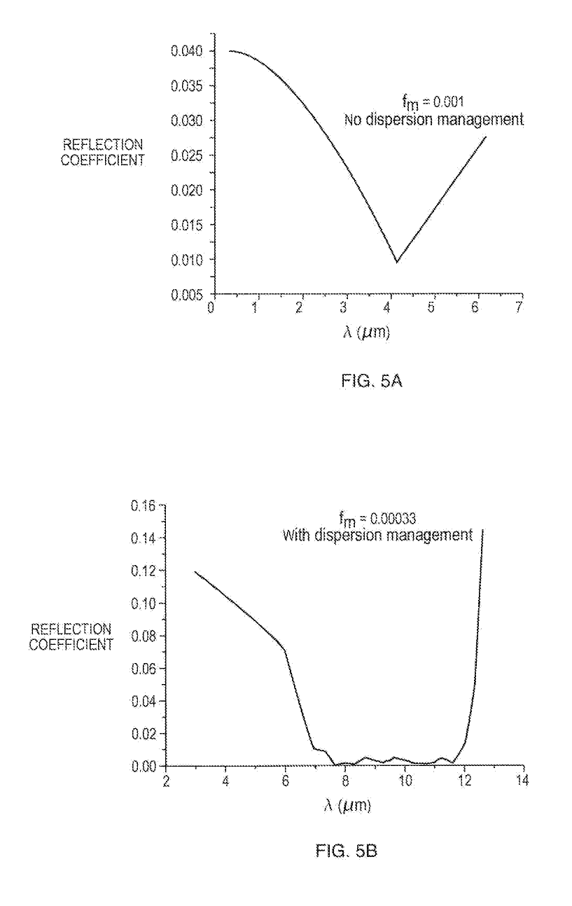

FIG. 5 demonstrates considerable improvement of the cloaking performance of the dispersion-compensated metamaterial compared to ordinary plasmonic antireflection coating, which provides reflection suppression only at one fixed wavelength of infrared light.

Those skilled in the art will appreciate other embodiments of our invention are the following:

Any low-loss metal may be used as a component of the composite metamaterial.

Any dielectric exhibiting anomalous dispersion may be used as a component of the composite metamaterial.

The dispersion of either or both the metal and the dielectric components of the composite metamaterial may be adjusted by nanostructuring or nanopatterning. For example, it may be achieved by producing various arrays of holes in the dielectric or metal layer. The metamaterial cloak can be deposited straight on the vehicle/tank surface or on the metal/plastic strips hung as “blinds”-type over an anti-RPG cage.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

what is claimed is:

1. A method of achieving electromagnetic cloaking of an object comprising the step of coating said object with a metal-dielectric composite material including a dielectric component, wherein the dielectric component is comprised of a material exhibiting anomalous dispersion in a wide wavelength range.

2. The method of claim 1 wherein the dielectric permittivity and refractive index increase with the increase of the wavelength of light.

3. The method of claim 2 wherein the metal dielectric permittivity is negative in the infrared and its magnitude increases with increases in the wavelength.

4. The method of claim 3 wherein the average reflective index of the metal-dielectric composite material may be kept in a wavelength range between μ=0 and μ=1.
